(19) United States
(12) Patent Application Publication
(10) Pub. No.: US 2013/0033667 A1
(43) Pub. Date: Feb. 7, 2013

(54) LIQUID CRYSTAL DISPLAY DEVICE

(71) Applicants: Syou YANAGISAWA, Mobara (JP); Tomokazu Ishikawa, Mobara (JP)

(72) Inventors: Syou YANAGISAWA, Mobara (JP); Tomokazu Ishikawa, Mobara (JP)

(73) Assignee: Japan Display East Inc.

(21) Appl. No.: 13/562,379

(22) Filed: Jul. 31, 2012

(30) Foreign Application Priority Data
Aug. 4, 2011 (JP) 2011-170741

(51) Int. Cl. G02F 1/1339

(52) U.S. Cl. 349/139

(57) ABSTRACT

Provided is a liquid crystal display device capable of securing a sufficient amount of light for curing a sealing material applied to a TFT substrate side, and adjusting resistances of wirings including scanning signal lines and video signal lines. The liquid crystal display device includes: a TFT substrate (11) including a pixel electrode provided thereon; an opposing substrate (20), which is opposed to the TFT substrate (11); and a liquid crystal sealed between the TFT substrate (11) and the opposing substrate (20), in which scanning lead-out lines (31, 32) traversing a sealing material (12) for sealing the liquid crystal each include slits (23, 33) each having a shape that is open on one side formed therein along a longitudinal direction of the scanning lead-out lines (31, 32).

### CROSS-REFERENCE TO RELATED APPLICATION

The present application claims priority from Japanese application JP 2011-170741 filed on Aug. 4, 2011, the content of which is hereby incorporated by reference into this application.

### BACKGROUND OF THE INVENTION

1. Field of the Invention

The present invention relates to a liquid crystal display device, and more particularly, to a technology for securing a certain aperture ratio in a liquid crystal display panel to which a sealing material made of an ultraviolet curable resin is applied.

2. Description of the Related Art

A liquid crystal display device of a thin film transistor (TFT) type including a liquid crystal display panel is widely used as a display portion of a mobile device such as a portable telephone. FIG. 5 is a view illustrating the schematic structure of a conventional liquid crystal display device, and FIG. 6 is an enlarged view of a wiring pattern in a part of FIG. 5. As illustrated in FIG. 5, a liquid crystal display device 100 includes a TFT substrate (array substrate) 110, and an opposing substrate (color filter substrate) 200 provided above the TFT substrate 110. The TFT substrate 110 includes a display portion 210, a frame portion 160, and a terminal portion 170. The frame portion 160 is formed around the display portion 210.

The TFT substrate 110 includes cells each including a TFT (not shown) and a pixel electrode (not shown) arranged to form an array (grid). On the other hand, the opposing substrate 200 includes a color filter (not shown), a common electrode (not shown), and the like. A liquid crystal layer (not shown) is sandwiched between the TFT substrate 110 and the opposing substrate 200. The TFT substrate 110 and the opposing substrate 200 are bonded with a sealing material 120 made of an ultraviolet curable resin. The sealing material 120 is formed to surround the display portion 210 as illustrated in FIG. 5. The TFT substrate 110 is formed to be larger in size than the opposing substrate 200, and a portion by which the TFT substrate 110 is larger in size than the opposing substrate 200 includes the terminal portion 170 formed thereon for supplying power, a video signal, a scanning signal, and the like to a liquid crystal cell.

The terminal portion 170 includes an integrated circuit (IC) driver 150 for driving scanning signal lines 130, video signal lines 140, and the like. The IC driver 150 is divided into three regions, of which the center region includes a video signal drive circuit 152 and the left end region and the right end region each include a scanning signal drive circuit 151.

In the display portion 210, the scanning signal lines (gate wirings) 130, 130, . . . extend in a horizontal direction and are arrayed in a vertical direction. Similarly, the video signal lines (drain wirings) 140, 140, . . . extend in the vertical direction and are arrayed in the horizontal direction. A region surrounded by the scanning signal lines 130, 130, . . . and the video signal lines 140, 140, . . . constitutes a pixel. The scanning signal lines 130, 130, . . . are connected to the scanning signal drive circuits 151 of the IC driver 150 through scanning lead-out lines 131, 131, . . . and scanning lead-out lines 132, 132, . . . , which are led out from both left and right sides of the display portion 210. The video signal lines 140, 140, . . . are connected to the video signal drive circuit 152 of the IC driver 150 through video lead-out lines 141, 141, . . . from a lower side of the display portion 210.

In FIG. 6, the scanning lead-out lines 132, 132, . . . are formed between adjacent ones of the scanning lead-out lines 131, 131, . . . . Note that, reference character 250 denotes a dummy pattern. The dummy patterns 250 are arranged at equal intervals, and as a result, an aperture portion 230 is formed between the dummy pattern 250 and the dummy pattern 250. The aperture portion 230 is provided to irradiate the sealing material 120 with ultraviolet light for curing the sealing material 120 from the TFT substrate 110 side or the opposing substrate 200 side. When a contaminant or a component in the sealing material 120 is eluted into the liquid crystal layer, the liquid crystal is altered to deteriorate display quality. Therefore, in order to cure the sealing material 120 as soon as possible, the aperture portion is provided in a portion in which the sealing material 120 intersects the scanning lead-out lines 131, 131, . . . and the scanning lead-out lines 132, 132, . . . (see, for example, Japanese Patent Application Laid-open No. 11-85057). Note that, after the liquid crystal is sealed between the opposing substrate 200 and the TFT substrate 110, the sealing material 120 is irradiated with the ultraviolet light to cure the sealing material 120, to thereby bond the opposing substrate 200 and the TFT substrate 110 through the intermediation of the liquid crystal.

Note that, the sealing material 120 is applied, in a process of producing a liquid crystal display panel constituting the liquid crystal display device 100, in a vicinity of a periphery portion between the TFT substrate 110 and the opposing substrate 200, on which the color filter and the like are formed, before bonding the substrates together. The liquid crystal is filled inside the sealing material 120. Thereafter, the substrates are placed on top of the other, and the sealing material 120 is irradiated with the ultraviolet light for curing the sealing material 120 from the TFT substrate 110 side or the opposing substrate 200 side, to thereby bond the substrates together (one drop fill (ODF) process).

### SUMMARY OF THE INVENTION

However, with a wiring pattern configuration of the scanning lead-out lines 131, 131, . . . and the scanning lead-out lines 132, 132, . . . as illustrated in FIG. 6, a dense portion (circular region Y illustrated in FIG. 6) and a sparse portion (circular region X illustrated in FIG. 6) are generated in the pattern. When the sealing material 120 is applied to the TFT substrate 110 side by the ODF process, the sealing material 120 flows from the dense portion to the sparse portion of the wiring pattern. As a result, the sealing material 120 is not applied uniformly to the TFT substrate 110 side, which results in an unevenness in the applied region and an increased possibility that the sealing material is peeled off. As a consequence, the display quality may be reduced.

Further, in order to adjust wiring resistances of the scanning lead-out lines 131, 131, . . . and the scanning lead-out lines 132, 132, . . . , widths of the wirings need to be adjusted as appropriate. For example, when the widths of the wirings are increased to reduce the wiring resistances, the aperture region becomes narrower, which makes it impossible to irradiate the sealing material 120 with a sufficient amount of ultraviolet light for curing the sealing material 120.

The present invention has been made in view of the above, and an object of the present invention is therefore to provide a liquid crystal display device capable of adjusting resistances of wirings including scanning signal lines and video signal lines without narrowing the aperture region for allowing passage of the ultraviolet light.

In order to solve the above-mentioned problems, according to the present invention, there is provided a liquid crystal display device, including: an array substrate including a pixel electrode provided thereon; an opposing substrate, which is opposed to the array substrate; and a liquid crystal sealed between the array substrate and the opposing substrate. At least a wiring traversing a sealing material for sealing the liquid crystal includes slits each having a shape that is open on one side formed therein along a longitudinal direction of the wiring.

According to the present invention, the wiring traversing the sealing material includes the slits each having the shape that is open on one side formed therein so that the slits themselves become the aperture regions for allowing the passage of the ultraviolet light, and hence a sufficient amount of ultraviolet light for curing the sealing material may be secured. Further, with the wiring including the slits formed therein, the width of the wiring is reduced in the portions in which the slits are formed. Therefore, the slits may be adjusted in length and width to adjust the overall resistance of the wirings.

Note that, other effects of the present invention become clear from the description of the entire specification.

### BRIEF DESCRIPTION OF THE DRAWINGS

In the accompanying drawings:

FIG. 1 is a view illustrating a configuration of a liquid crystal display device according to a first embodiment of the present invention;

FIG. 2 is a partially enlarged view of a portion in which lead-out lines traverse a sealing material of FIG. 1;

FIG. 3 is a view illustrating a configuration of a liquid crystal display device according to a second embodiment of the present invention;

FIG. 4 is a partially enlarged view of a portion in which lead-out lines traverse a sealing material of FIG. 3;

FIG. 5 is a view illustrating a configuration of a conventional liquid crystal display device; and

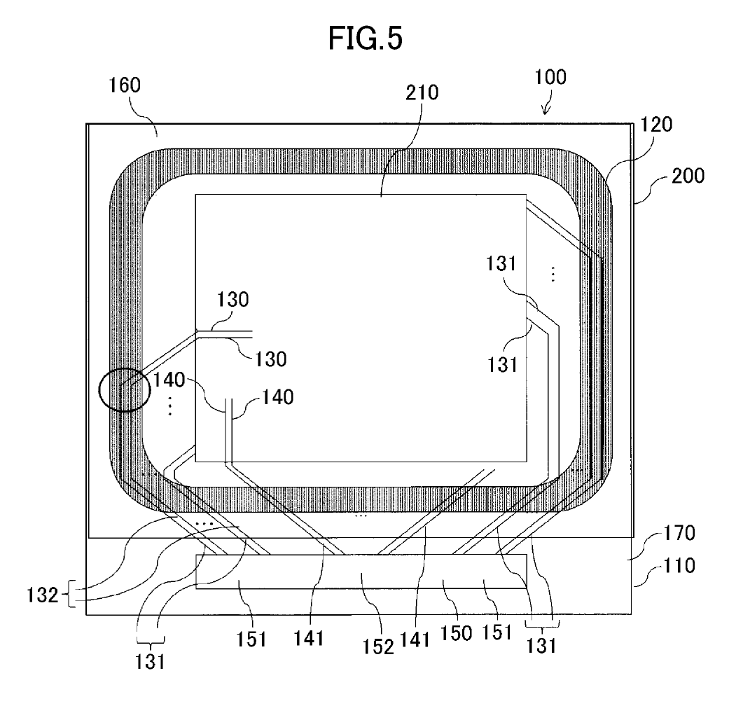

FIG. 6 is a partially enlarged view of a portion in which lead-out lines traverse a sealing material of FIG. 5.

### DETAILED DESCRIPTION OF THE INVENTION

Hereinafter, embodiments to which the present invention is applied are described with reference to the accompanying drawings. In the following description, the same reference characters are given to the same components, and redundant description thereof is omitted.

### First Embodiment

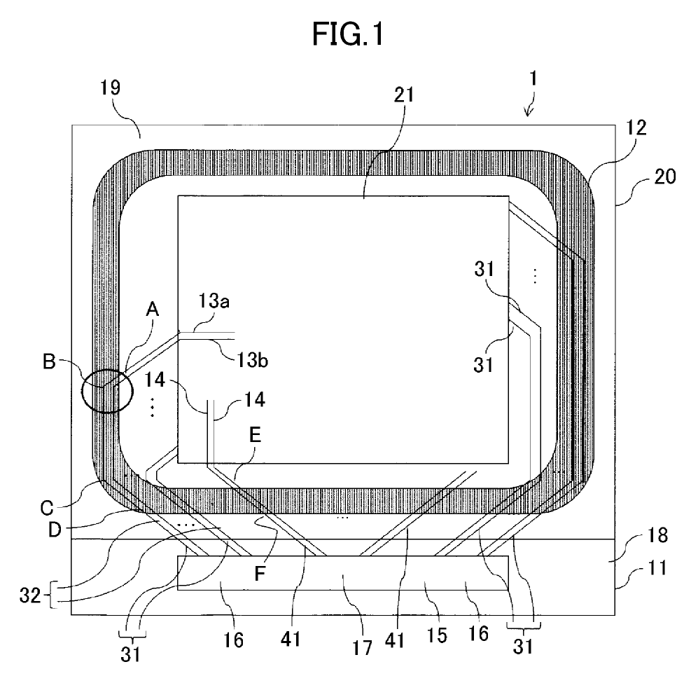

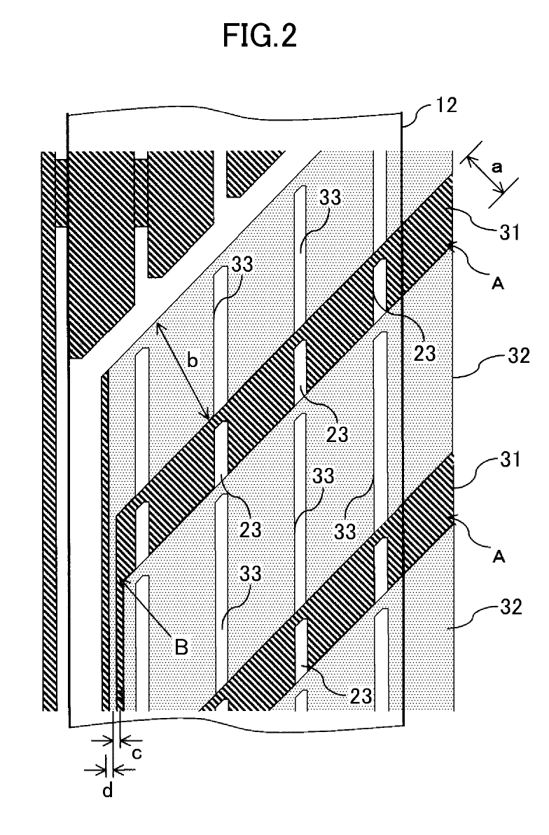

FIG. 1 is a view illustrating a configuration of a liquid crystal display device according to a first embodiment of the present invention, and FIG. 2 is a partially enlarged view of a portion in which lead-out lines traverse a sealing material of FIG. 1. Now, referring to FIGS. 1 and 2, a liquid crystal display device 1 according to the first embodiment is described. As illustrated in FIG. 1, the liquid crystal display device 1 includes a TFT substrate 11, and an opposing substrate 20 provided above the TFT substrate 11 so as to be opposed to the TFT substrate 11. A liquid crystal layer (not shown) is sandwiched between the TFT substrate 11 and the opposing substrate 20. The TFT substrate 11 and the opposing substrate 20 are bonded with a sealing material 12 made of an ultraviolet curable resin formed in a frame portion 19.

The TFT substrate 11 is formed to be larger in size than the opposing substrate 20. A region of the TFT substrate 11 excluding the opposing substrate 20 includes a terminal portion 18 formed thereon for supplying power, a video signal, a scanning signal, and the like to a liquid crystal cell.

The terminal portion 18 includes an integrated circuit (IC) driver 15 for driving scanning signal lines 13a and 13b, video signal lines 14, and the like. The IC driver 15 is divided into three regions (center region, left end region, and right end region), of which the center region includes a video signal drive circuit 17 and the left end region and the right end region each include a scanning signal drive circuit 16.

In the display portion 21, the scanning signal lines (gate wirings) 13a, 13b, 13a, . . . extend in a horizontal direction and are arrayed in a vertical direction. Similarly, the video signal lines (drain wirings) 14, 14, . . . extend in the vertical direction and are arrayed in the horizontal direction. A region surrounded by the scanning signal lines 13a, 13b, 13a, . . . and the video signal lines 14, 14, . . . constitutes a pixel.

The scanning signal lines 13a are connected to the scanning signal drive circuits 16 of the IC driver 15 through scanning lead-out lines 31, 31, . . . , which are led out from both sides of the display portion 21. The scanning signal lines 13b are connected to the scanning signal drive circuits 16 of the IC driver 15 through scanning lead-out lines 32, 32, . . . . Note that, the scanning lead-out lines 32, 32, . . . are formed in a layer different from that of the scanning lead-out lines 31, 31, . . . through the intermediation of an insulating layer (not shown).

Next, the video signal lines 14, 14, . . . are connected to the video signal drive circuit 17 of the IC driver 15 through video lead-out lines 41, 41, . . . led out from a lower side of the display portion 21. In the first embodiment, the material of the scanning signal lines 13a and the material of the scanning signal lines 13b are different from each other, with the scanning signal lines 13a being formed of, for example, a gate metal, and the scanning signal lines 13b being formed of, for example, the same material as the drain wirings. Note that, the material of the scanning signal lines 13a and the material of the scanning signal lines 13b are not limited thereto.

As illustrated in FIG. 2, in a section in which the scanning lead-out lines 31, 31, . . . traverse the sealing material 12, that is, in a section from a point at which the scanning lead-out lines 31, 31, . . . start to overlap the sealing material 12 (point A) to a point at which a wiring direction is changed (point B) (section A-B), the scanning lead-out lines 31, 31, . . . have a wiring width of a. In a section from the point at which the wiring direction is changed (point B) to a point at which the scanning lead-out lines 31, 31, . . . is routed straight so as not to extend beyond the sealing material 12 and is changed again in the wiring direction (point C (see FIG. 1)) (section B-C), the scanning lead-out lines 31, 31, . . . have a wiring width of c (provided that c<a). Further, in a section from the point C to a point at which the wirings extend beyond the sealing material 12 (point D (see FIG. 1)) (section C-D) , the scanning lead-out lines 31, 31, . . . have a wiring width of e (provided that e<a).

In a section in which the scanning lead-out lines 32, 32, . . . traverse the sealing material 12, that is, in a section from a point at which the scanning lead-out lines 32, 32, . . . start to overlap the sealing material 12 (point A) to a point at which a wiring direction is changed (point B) (section A-B), the scanning lead-out lines 32, 32, . . . have a wiring width of b. In a section from the point at which the wiring direction is changed (point B) to a point at which the scanning lead-out lines 32, 32, . . . is routed straight so as not to extend beyond the sealing material 12 and is changed again in the wiring direction (point C (see FIG. 1)) (section B-C), the scanning lead-out lines 32, 32, . . . have a wiring width of d (provided that d<b). Further, in a section from the point C to a point at which the wirings extend beyond the sealing material 12 (point D (see FIG. 1)) (section C-D), the scanning lead-out lines 32, 32, . . . have a wiring width of f (provided that f<b).

In this example, the scanning lead-out lines 31, 31, . . . include substantially rectangular slits (aperture portions: open white portions in the FIG. 23 formed therein at equal intervals along a longitudinal direction thereof and at a cutout angle of 45° up to the right with respect to the longitudinal direction. The slits 23 are formed to have a predetermined length and width, and one side of the slits 23 is open. The slits 23 are each open on one side so that wiring resistances do not become excessively lower than a desired wiring resistance. The wiring resistances are determined by the widths of the wirings, provided that the wirings are made of the same material. Therefore, adjustment to the desired wiring resistance may be made by simply changing the width and length of the slits.

Note that, as long as the condition that an aperture ratio is equal to or more than a predetermined value is satisfied, the length and width of the slits 23 may be varied for each slit, the slits do not need to be arranged at equal intervals, or the cutout angle of the slits is not limited to 45°. The same is true for slits 33 to be described later.

Note that, by employing the aperture shape having the aperture ratio as illustrated in FIG. 2, for example, the sealing material 12 may be irradiated with ultraviolet light more uniformly. As used herein, the term “aperture ratio” means a ratio of a region of a predetermined region on the sealing material excluding the region of the lead-out lines allocated to the predetermined region with respect to the predetermined region on the sealing material.

On the other hand, the video lead-out lines 41 have the same wiring width from an overlapping start point (point E) to an overlapping end point (point F).

Next, the scanning lead-out lines 32, 32, . . . include slits (aperture portions) 33 formed therein at equal intervals along a longitudinal direction thereof and at a cutout angle of 45° up to the right with respect to the longitudinal direction. The slits 33 are formed to have a predetermined width and length, and one side of the slits 33 is open. The slits 33 are each open on one side so that resistances of the scanning lead-out lines 32, 32, . . . , do not become excessively lower than a desired wiring resistance, as in the above-mentioned scanning lead-out lines 31, 31, . . . .

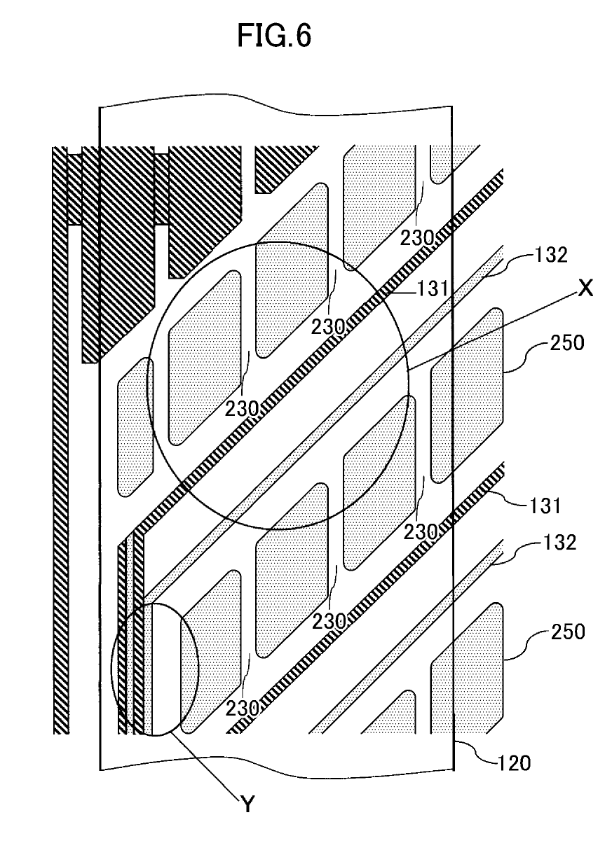

As described above, according to the first embodiment, by forming each of the scanning lead-out lines 31, 31, . . . and the scanning lead-out lines 32, 32, . . . so as to have a larger wiring width when traversing the sealing material 12 than that when extending substantially parallel to the longitudinal direction of the sealing material 12, the wiring width in an otherwise sparse portion of the pattern is increased. Therefore, no sparse portion is generated, and the phenomenon which occurs in the above-mentioned conventional lead-out line structure (see FIG. 6), that is, the phenomenon that the sealing material 12 flows from the dense portion to the sparse portion, is resolved.

Therefore, the sealing material 12 is applied uniformly to the TFT substrate 11 side, which results in no unevenness in the applied region and a reduced possibility that the sealing material 12 is peeled off. As a consequence, the display quality may be improved.

Further, with the scanning lead-out lines 31, 31, . . . including the slits 23 each having the shape that is open on one side formed therein at equal intervals and with the scanning lead-out lines 32, 32, . . . including the slits 33 each having the shape that is open on one side formed therein at equal intervals, the shape of the wiring pattern may be regarded as a pattern in which wide lines and narrow lines are formed alternately and repeatedly along the longitudinal direction of the lead-out lines (pattern having a concavo-convex shape when viewed from directly above). Therefore, it is possible to obtain the effect of preventing the wiring resistances from becoming excessively lower than the desired wiring resistance of the scanning signal lines and the video signal lines (and of maintaining high resistance).

Further, the wiring resistances may be adjusted with high accuracy by adjusting the wiring width, the width and length of the slits, and the interval between the adjacent slits as appropriate.

Further, the above-mentioned first embodiment may be implemented in a place (small space) where the sealing material and the lead-out lines intersect each other, and hence may be applied to a liquid crystal display device having a narrow frame.

### Second Embodiment

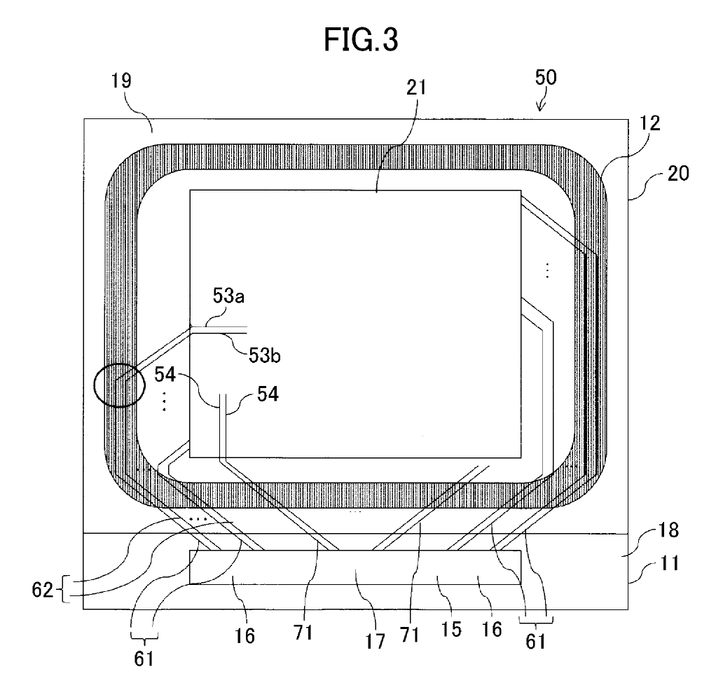

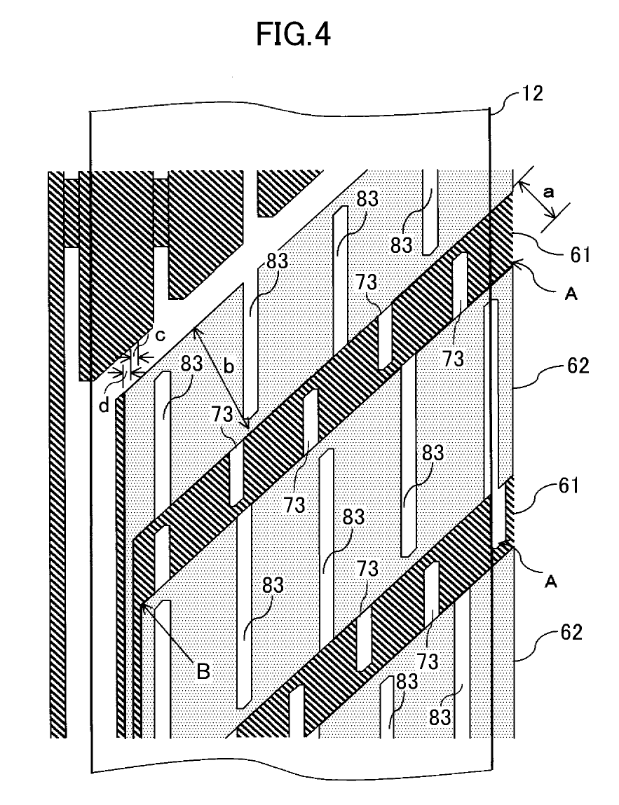

FIG. 3 is a view illustrating a configuration of a liquid crystal display device 50 according to a second embodiment of the present invention, and FIG. 4 is a partially enlarged view of a portion in which lead-out lines traverse a sealing material of FIG. 3. Now, referring to FIGS. 3 and 4, the liquid crystal display device 50 according to the second embodiment is described.

Note that, the liquid crystal display device 50 of the second embodiment is the same as in the first embodiment except that scanning lead-out lines 61, 61, . . . and scanning lead-out lines 62, 62, . . . have different shapes in the region in which the scanning lead-out lines 61, 61, . . . , and the scanning lead-out lines 62, 62, . . . traverse (intersect) the sealing material 12, and hence redundant description thereof is omitted. Further, the points A to F are omitted in the description of FIGS. 3 and 4, but the points A to F are located at the same positions as those of the points A to F illustrated in FIGS. 1 and 2.

In the display portion 21, scanning signal lines 53a, 53b, 53a, . . . extend in the horizontal direction and are arrayed in the vertical direction. Video signal lines (for example, drain wirings) 54, 54, . . . extend in the vertical direction and are arrayed in the horizontal direction. A region surrounded by the scanning signal lines 53a, 53b, 53a, . . . and the video signal lines 54, 54, . . . constitutes a pixel.

The scanning signal lines 53a are connected to the scanning signal drive circuits 16 of the IC driver 15 through the scanning lead-out lines 61, 61, . . . , which are led out from both sides of the display portion 21. The scanning signal lines 53b are connected to the scanning signal drive circuits 16 of the IC driver 15 through the scanning lead-out lines 62, 62, . . . . Note that, the scanning lead-out lines 62, 62, . . . are formed in a layer different from that of the scanning lead-out lines 61, 61, . . . through the intermediation of an insulating layer (not shown).

Next, the video signal lines 54, 54, . . . are connected to the video signal drive circuit 17 of the IC driver 15 through video lead-out lines 71, 71, . . . led out from the lower side of the display portion 21.

In the second embodiment, the material of the scanning signal lines 53a and the material of the scanning signal lines 53b are different from each other, with the scanning signal lines 53a being formed of, for example, a gate metal, and the scanning signal lines 53b being formed of, for example, the same material as the drain wirings. Note that, the material of the scanning signal lines 53a and the material of the scanning signal lines 53b are not limited thereto.

As illustrated in FIG. 4, the scanning lead-out lines 61, 61, . . . include substantially rectangular slits (aperture portions: open white portions in the FIG. 73 formed therein at equal intervals along a longitudinal direction thereof and at a cutout angle of 45° up to the right with respect to the longitudinal direction.

The slits 73 are formed to have a predetermined length and width, and one side of the slits 33 is open. The slits 73 each have a shape that is open on one side as in the above-mentioned first embodiment, and are the same as in the above-mentioned first embodiment except that the adjacent slits 73 are open on different sides. With this configuration, the scanning lead-out lines 61, 61, . . . may be made serpentine. Note that, the slits 73 are each open on one side for the same reason as in the above-mentioned first embodiment, and as long as the condition that the aperture ratio is equal to or more than the predetermined value is satisfied, the length and width of the slits 73 may be varied for each slit, the slits do not need to be arranged at equal intervals, or the cutout angle of the slits is not limited to 45°. The same is true for slits 83 to be described later.

On the other hand, the video lead-out lines 71 have the same wiring width from the overlapping start point (point E) to the overlapping end point (point F).

Next, the scanning lead-out lines 62, 62, . . . include slits (aperture portions) 83 formed therein at equal intervals along a longitudinal direction thereof and at a cutout angle of 45° up to the right with respect to the longitudinal direction. The slits 83 are formed to have a predetermined width and length, and one side of the slits 83 is open. The difference from the above-mentioned first embodiment is that the adjacent slits 83 are open on different sides. With this configuration, the scanning lead-out lines 62, 62, . . . may be made serpentine. Note that, the aperture portions 83 are each open on one side for the same reason as that for the above-mentioned scanning lead-out lines 61, 61, . . . .

As described above, according to the second embodiment, the open portions of the slits 73 in the scanning lead-out lines 61, 61, . . . are different between the adjacent slits, and hence the pattern shape may be made serpentine. Therefore, it is possible to obtain the effect that the wiring resistances may be adjusted with even higher accuracy by adjusting the number of serpentine curves in addition to the adjustment of the wiring width, the width and length of the slits, and the interval between the adjacent slits.

While there have been described what are at present considered to be certain embodiments of the invention, it will be understood that various modifications may be made thereto, and it is intended that the appended claims cover all such modifications as fall within the true spirit and scope of the invention.

For example, the liquid crystal display device according to the present invention is not limited to the twisted nematic (TN) mode, but can also be applied to the in-plane switching (IPS) mode and the like.

What is claimed is:

1. A liquid crystal display device, comprising:
an array substrate including a pixel electrode provided thereon;
an opposing substrate, which is opposed to the array substrate; and
a liquid crystal sealed between the array substrate and the opposing substrate,
wherein at least a wiring traversing a sealing material for sealing the liquid crystal includes slits each having a shape that is open on one side formed therein along a longitudinal direction of the wiring.

2. The liquid crystal display device according to claim 1, wherein opening ends of the slits are formed alternately at one side and another side of the wiring so that the wiring traversing the sealing material has a pattern shape including at least one serpentine curve.

3. The liquid crystal display device according to claim 2, wherein the wiring traversing the sealing material comprises at least two wirings, and a width and a number of the serpentine curves of each of the at least two wirings are adjusted so that adjacent wirings have a fixed resistance.
